(19) United States
(12) Patent Application Publication
(10) Pub. No.: US 2015/0064347 A1
(43) Pub. Date: Mar. 5, 2015

(54) METHOD FOR PRODUCING HARD DISK SUBSTRATE

(71) Applicant: Toyo Kohan Co., Ltd., Tokyo (JP)

(72) Inventors: Gen Ishida, Yamaguchi (JP); Nobuaki Mukai, Yamaguchi (JP); Takahiro Yoshida, Yamaguchi (JP)

(73) Assignee: Toyo Kohan Co., Ltd., Tokyo (JP)

(21) Appl. No.: 14/391,509

(22) PCT Filed: Apr. 2, 2013
(86) PCT No.: PCT/JP2013/060096

§ 371 Date: Oct. 9, 2014

(30) Foreign Application Priority Data
Apr. 10, 2012 (JP) 2012-089685

(51) Int. Cl. G11B 5/858

(52) U.S. Cl. CPC G11B 5/858
USPC 427/131; 427/130

(57) ABSTRACT

An object of the present invention is to obtain a hard disk substrate that can have a smooth surface of a plating film through electroless NiP plating and does not have deteriorated corrosion resistance against acid solutions. A method for producing a hard disk substrate of the present invention includes a first plating step of immersing a substrate in a first electroless NiP plating bath containing an additive with leveling action, thereby forming a lower layer of the electroless NiP plating film on a surface of the substrate, the lower layer having smaller average surface roughness than the surface; and a second plating step of immersing the substrate that has the lower layer of the electroless NiP plating film formed thereon through the first plating step in a second electroless NiP plating bath, thereby forming an upper layer of the electroless NiP plating film, the upper layer having corrosion resistance against acid solutions. Exposure of the lower layer to the atmosphere is suppressed in the period during transition from the first plating step to the second plating step.

### TECHNICAL FIELD

The present invention relates to a method for producing a hard disk substrate.

### BACKGROUND ART

As a method for producing a hard disk substrate, there has been performed a method that includes applying electroless NiP plating to an aluminum or aluminum alloy substrate, which has been mechanically processed, to form a plating film on the surface of the substrate so that the plating film is used as a base of a magnetic film (see Patent Literature 1).

Herein, in order to achieve high recording density of a hard disk recording device, it is necessary to set the flying height of a recording/reading head as low as possible. Thus, after a plating film is formed through electroless NiP plating, a polishing step of smoothing the surface of the plating film is performed by polishing the surface with free abrasive grains.

### CITATION LIST

### Patent Literature

Patent Literature 1: JP H03-236476 A

### SUMMARY OF INVENTION

### Technical Problem

However, as the surface of the plating film formed through electroless NiP plating is quite rough, great burdens are imposed on the polishing step. Further, as the removal thickness with polishing is also large, the thickness of the plating film should also be increased, which in turn could decrease the productivity and increase environmental burdens.

In view of the foregoing, it is desired that the surface of the plating film formed through electroless NiP plating be as smooth as possible to reduce burdens on the polishing step. In a method of forming a plating film on a printed board or the like, for example, a brighter, such as an organosulfur compound, is added into an electroless plating bath to obtain a plating film with a smooth surface.

However, a plating film containing sulfur typically has low corrosion resistance against acid solutions, and in particular, when a method for producing a hard disk substrate in which a strong-acid polishing agent is used in a polishing step is used, it is concerned that defects such as corrosion pits may be generated on the surface of the resulting plating film. Thus, the techniques for printed boards and the like cannot be applied directly. Further, when the corrosion resistance against acid solutions of a plating film is low, it is concerned that an excess amount of Ni in the plating film may preferentially elute even while strong acid washing is performed, which in turn could cause failure in the following steps for the hard disk substrate.

The present invention has been made in view of the foregoing, and it is an object of the present invention to supply a hard disk substrate that can have a smooth surface of a plating film through electroless NiP plating and does not have deteriorated corrosion resistance against acid solutions.

### Solution to Problem

A method for producing a hard disk substrate of the present invention for solving the above problem is a method for producing a hard disk substrate with an electroless NiP plating film, including a first plating step of immersing a substrate in a first electroless NiP plating bath containing an additive with leveling action, thereby forming a lower layer of the electroless NiP plating film on a surface of the substrate, the lower layer having smaller average surface roughness than the surface; and a second plating step of immersing the substrate that has the lower layer of the electroless NiP plating film formed thereon through the first plating step in a second electroless NiP plating bath. In a period during transition from the first plating step to the second plating step, exposure of the lower layer of the plating film to the atmosphere is suppressed.

### Advantageous Effects of Invention

According to the aforementioned method for producing a hard disk substrate, the lower layer of the electroless NiP plating film is formed on the surface of a substrate by immersing the substrate in a first electroless NiP plating bath containing an additive with leveling action, such as an organosulfur compound. Thus, the surface roughness of the lower layer can be suppressed, and the surface of the lower layer can thus be smooth.

In addition, as the upper layer of the electroless NiP plating film is formed on the smoothed surface of the lower layer by immersing the substrate, which has the lower layer of the electroless NiP plating film formed thereon, in a second electroless NiP plating bath with corrosion resistance against acid solutions, the surface roughness of the upper layer can be suppressed, and the surface of the upper layer can thus be smooth. Further, as the surface of the lower layer can be covered with the upper layer with corrosion resistance against acid solutions, corrosion resistance against acid solutions will not deteriorate in the polishing step or the washing step.

Thus, burdens on the polishing step can be reduced, and the productivity of hard disk substrates can be improved. Further, as the amount of a polishing waste liquid that is discharged in the polishing step can be reduced, the removal thickness with polishing can be suppressed, and the thickness of the plating film can be reduced, environmental burdens can also be reduced.

According to the aforementioned method for producing a hard disk substrate of the present invention, exposure of the lower layer to the atmosphere is suppressed in the period during transition from the first plating step of forming the lower layer to the second plating step of forming the upper layer. Thus, formation of an oxide film on the surface of the lower layer of the plating film can be avoided. Thus, it is possible to suppress generation of pits, which are recess defects originating from an oxide film on the lower layer of the plating film, on the surface of the upper layer of the plating film when the upper layer is formed through the second plating step or when a polishing step is performed after the second polishing step.

Thus, it is possible to obtain a smooth hard disk substrate and avoid generation of corrosion in the lower layer of the plating film starting from the pits generated in the upper layer of the electroless NiP plating film, which could otherwise deteriorate the corrosion resistance against acid solutions. In addition, according to the present invention, as the number of pits that are generated in the upper layer of the electroless NiP plating film can be reduced, a decrease in the recording capacity of a hard disk recording device can be avoided.

### BRIEF DESCRIPTION OF DRAWINGS

FIG. 1 is a diagram showing the measurement results in Example 1-1 and Comparative Examples 1-1 and 1-2.

FIG. 2 is a diagram showing the measurement results in Example 1-2.

FIG. 3 is a diagram showing the measurement results of the surface roughness in Example 1-3.

FIG. 4 is a diagram showing the measurement results of the diameters of nodules and the heights of nodules in Example 1-3.

FIG. 5 is a diagram showing the measurement results of waviness in Example 1-3.

FIG. 6 is a diagram showing an image of the surface of an upper layer of a plating film in Example 2.

FIG. 7 is a graph showing the relationship between the oxygen detection intensity and the depth from the surface of the oxide film.

### DESCRIPTION OF EMBODIMENTS

Hereinafter, the present embodiment will be described in detail.

A method for producing a hard disk substrate includes a substrate forming step of forming a substrate by grinding an aluminum blank material, a plating step of applying electroless NiP plating to the substrate to form an electroless NiP plating film on the surface of the substrate, a polishing step of polishing the surface of the substrate having the electroless NiP plating film formed thereon to obtain a mirror surface, and a washing step of washing the polished plating film.

Among the aforementioned steps, the plating step can include (1) a degreasing step, (2) water washing, (3) etching treatment, (4) water washing, (5) desmutting treatment, (6) water washing, (7) first zincate treatment, (8) water washing, (9) de-zincate treatment, (10) water washing, (11) secondary zincate treatment, (12) water washing, (13) electroless NiP plating, (14) water washing, (15) drying, and (16) annealing. The (13) electroless NiP plating can be performed in two stages including a first plating step and a second plating step.

In the first plating step, the substrate is immersed in a first electroless NiP plating bath containing an additive with leveling action so that a lower layer of an electroless NiP plating film is formed on the surface of the substrate. Through such a process, an electroless NiP plating film with smaller average surface roughness than that of the aluminum blank material can be formed. It should be noted that an organosulfur compound can be used for the additive with leveling action.

It is considered that such an additive with leveling action will deposit on projections of the aluminum blank material with irregularities, and delay the growth of electroless NiP plating at the projections than at other portions, and thus has the action of reducing the influence of irregularities of the aluminum blank material, so that a smooth plating film can be obtained.

In the second plating step, the substrate, which has the lower layer of the electroless NiP plating film formed thereon through the first plating step, is immersed in a second electroless NiP plating bath with corrosion resistance against acid solutions, whereby an upper layer of the electroless NiP plating film with corrosion resistance against acid solutions is formed. In order to form an electroless NiP plating film with corrosion resistance against acid solutions, a plating bath that contains no organosulfur compound added thereto can be used.

It should be noted that the phrase “having corrosion resistance against acid solutions” herein means having at least about the same degree of corrosion resistance against acid solutions as those of the conventionally used electroless NiP plating films. To this end, an organosulfur compound is preferably not positively added into the plating path, but inclusion of the amount of an organosulfur compound due to contamination that will not influence the corrosion resistance against acid solutions is acceptable.

In the conventional electroless NiP plating, a single layer of an electroless NiP plating film is formed through a single plating step. Thus, the plating thickness is about 10 to 15 μm, for example, which is thicker than the upper layer of the electroless NiP plating film in this embodiment. Thus, even if pinholes are generated in the beginning of deposition of plating, there is a low possibility that the pinholes will appear as pits on the surface of the plating film as the pinholes may be filled while a plating film grows. Further, even if the pinholes remain as voids in the plating film, there is a low possibility that the pinholes may appear as pits on the surface of the plating film after a polishing step as the pinholes are present around the interface with the aluminum blank material.

Meanwhile, in the electroless NiP plating in this embodiment, the lower layer is formed through the first plating step and the upper layer is formed through the second plating step, whereby an electroless NiP plating film with a two-layer structure of the upper and lower layers is formed.

In such a method for producing a two-layer structure, however, the surface of the lower layer of the plating film is exposed to the atmosphere and an oxide film is thus formed in the period during transition from the first plating step of forming the lower layer to the second plating step of forming the upper layer. When the oxide film is extremely thin, the surface of the lower layer of the plating film is active. Thus, dense nucleation of NiP plating occurs during plating of the upper layer of the electroless NiP plating film, and the NiP plating immediately grows in a film shape.

However, when the oxide film formed on the surface of the lower layer of the plating film is thick, it is considered that the surface of the lower layer of the plating film becomes inactive, and deposition of electroless NiP plating of the upper layer is thus delayed at the inactive portions. Thus, sparse nucleation of NiP plating occurs, and the NiP plating grows in island shapes, and then grows in film shapes. Thus, as the boundary portions between the islands are not completely filled, there is a possibility that mesh-like recess defects having pinholes or voids may be generated on the surface of the upper layer of the plating film, and a number of pits may thus be generated on the surface of the substrate after polishing is performed.

In particular, as the oxide film formed on the surface of the lower layer of the electroless NiP plating film is thicker, it is concerned that the number of mesh-like recess defects generated on the upper layer of the electroless NiP plating film may increase, and a number of pits may thus appear on the surface of the upper layer of the plating film after polishing is performed. Thus, it is concerned that corrosion of the lower layer of the plating film may be generated starting from the pits, which could deteriorate the corrosion resistance against acid solutions, or the number of portions where data cannot be recorded after a magnetic recording layer is completed may increase, which could decrease the decreased recording capacity of a hard disk recording device.

Thus, in this embodiment, in the period during transition from the first plating step to the second plating step, exposure of the lower layer to the atmosphere is suppressed to avoid formation of a thick oxide film on the surface of the lower layer of the plating film, and thus suppress generation of mesh-like recess defects, which originate from the oxide film, on the surface of the upper layer of the plating film, and avoid appearance of pits after polishing is performed. Thus, it is possible to obtain a smooth hard disk substrate, and avoid generation of corrosion in the lower layer of the plating film starting from the pits generated in the upper layer of the electroless NiP plating film, which could otherwise deteriorate the corrosion resistance against acid solutions. In addition, a decrease in the recording capacity of a hard disk recording device can be avoided.

As an exemplary method for suppressing exposure of the lower layer to the atmosphere, there are known a method of, for example, setting the time in which the surface of the lower layer of the plating film is exposed to the atmosphere as short as possible by transitioning from the first plating step to the second plating step in a short time, and a method of, when the substrate is washed with pure water after the first plating step, transitioning to the second plating step to immerse the substrate in a second plating bath while maintaining the wet condition in which the pure water used for the water washing adheres to the surface of the lower layer of the plating film. Further, there is also known a method of transitioning to the second plating step in an inert gas atmosphere of nitrogen, argon, or the like.

For the first and second electroless NiP plating baths, a water-soluble nickel salt is used as a source of supply of nickel ions. As such a water-soluble nickel salt, nickel sulfate, nickel chloride, nickel carbonate, nickel acetate, nickel sulfamate, or the like can be used. The concentration of metallic nickel in the plating bath is preferably 1 to 30 g/L.

As a complexing agent, two or more of dicarboxylic acid; an alkali salt thereof, for example, tartaric acid, malic acid, citric acid, succinic acid, malonic acid, glycolic acid, gluconic acid, oxalic acid, phthalic acid, fumaric acid, maleic acid, or lactic acid; sodium salt thereof; potassium salt thereof; and ammonium salt thereof are preferably used. Preferably, at least one of them is oxydicarboxylic acid. The concentration of the complexing agent is preferably 0.01 to 2.0 mol/L.

As a reducing agent, hypophosphorous acid or hypophosphite such as sodium hypophosphite or potassium hypophosphite is preferably used. The concentration of the reducing agent is preferably 5 to 80 g/L.

In the first plating step, electroless NiP plating is preferably performed using a first electroless NiP plating bath containing a brighter, such as an organosulfur compound, added thereto as an additive with leveling action in order to smooth the surface of the electroless NiP plating film as a lower layer. Through such a process, an electroless NiP plating film with smaller average surface roughness than that of the aluminum blank material can be formed.

Any organosulfur compound that contains sulfur atoms in the structural formula can be used. For example, thiourea, sodium thiosulfate, sulfonate, isothiazolone compound, sodium lauryl sulfate, 2,2′-dipyridyl disulfide, 2,2′-dithiodibenzoic acid, bis(disulfide), or the like can be used either alone or in combination of two or more. More preferably, an organosulfur compound that contains nitrogen, such as thiourea, isothiazolone compound, 2,2′-dipyridyl disulfide, or bis(disulfide) is preferably used. The amount of addition of the organosulfur compound is preferably 0.01 to 20 ppm, and particularly preferably, 0.1 to 5 ppm. When the amount of addition is too small, there will be no leveling effect for the plating film, while when the amount of addition is too large, no higher effect is recognized.

A brighter like the aforementioned organosulfur compound is less toxic than brighter containing Cd, As, Tl, and the like, and thus are often suitable for practical use.

The first electroless NiP plating bath preferably further contains a pH controlling agent for acids, alkalis, salts, and the like, a preservative for avoiding generation of mold in the plating bath while the bath contains compounds therein, a buffer agent for suppressing fluctuations of pH, a surfactant for suppressing generation of pinholes, and a stabilizer for suppressing decomposition in the plating bath.

In the second plating step, electroless NiP plating is preferably performed using a second electroless NiP plating bath not containing an organosulfur compound. The second electroless NiP plating bath is the one that is typically used in the production of hard disk substrates, and has corrosion resistance against acid solutions against a polishing step that is performed after the plating step. Further, the second electroless NiP plating bath also has corrosion resistance against a strong acid washing step.

Between the first plating step and the second plating step, a washing step of washing the substrate with wash solution, such as pure water, is performed after the first plating step to avoid inclusion of the organosulfur compound contained in the first plating bath into the second plating bath. In that case, transition to the second plating step is carried out while the wet condition in which the substrate surface is wet with the wash solution is maintained. For example, when the substrate is quickly transitioned to the second plating step before the wash solution that has adhered to the substrate surface in the washing step becomes dry, it is possible to maintain the substrate surface in the wet condition. Thus, it is possible to suppress exposure of the lower layer to the atmosphere and thus suppress formation of an oxide film on the surface of the lower layer of the plating film.

According to the aforementioned method for producing a hard disk substrate, the lower layer of the electroless NiP plating film is formed on the surface of a substrate by immersing the substrate in a first electroless NiP plating bath containing an additive with leveling action, such as an organosulfur compound. Thus, the surface roughness of the lower layer can be suppressed, and the surface of the lower layer can thus be smooth.

In addition, as the upper layer of the electroless NiP plating film is formed on the smoothed surface of the lower layer by immersing the substrate, which has the lower layer of the electroless NiP plating film formed thereon, in a second electroless NiP plating bath with corrosion resistance against acid solutions, the surface roughness of the upper layer can be suppressed, and the surface of the upper layer can thus be smooth. Further, as the surface of the lower layer can be covered with the upper layer with aid corrosion resistance, corrosion resistance against acid solutions will not deteriorate in the polishing step or the washing step.

Thus, as a smooth hard disk substrate can be obtained, burdens on the polishing step can be reduced, and the productivity of hard disk substrates can thus be improved. Further, as the amount of a polishing waste liquid that is discharged in the polishing step can be reduced, the removal thickness with polishing can be suppressed, and the thickness of the plating film can be reduced, environmental burdens can also be reduced.

Further, according to the aforementioned method for producing a hard disk substrate, exposure of the lower layer to the atmosphere is suppressed in the period during transition from the first plating step of forming the lower layer to the second plating step of forming the upper layer. Thus, formation of an oxide film on the surface of the lower layer of the plating film can be avoided. Thus, it is possible to, when the upper layer is formed through the second plating step, avoid generation of mesh-like recess defects, which originate from the oxide film, on the surface of the upper layer of the plating film, and thus avoid appearance of pits after polishing is performed.

Thus, it is possible to obtain a smooth hard disk substrate, and avoid generation of corrosion of the lower layer of the plating film starting from pits in the upper layer of the electroless NiP plating film, which could otherwise deteriorate the corrosion resistance against acid solutions. In addition, according to the present invention, as the number of pits that are generated in the upper layer of the electroless NiP plating film can be reduced, a decrease in the recording capacity of a hard disk recording device can be avoided.

### EXAMPLES

Although the present invention will be hereinafter described in detail with reference to examples and comparative examples, the present invention is not limited to the following examples.

### Example 1

Example 1 was implemented to observe the state of the surface roughness of the upper layer after the first plating step and the second plating step.

### <Pretreatment Step>

A commercially available 3.5-inch aluminum substrate (95 mm—an inner diameter φ of 25 mm) with an average surface roughness of Ra=15 nm was subjected to degreasing treatment at 50° C. for 2 minutes using a degreasing liquid containing known soda phosphate and surfactant. Then, the substrate was subjected to etching treatment at 70° C. for 2 minutes using a known etching solution containing sulfuric acid and phosphoric acid.

Further, desmutting treatment was performed at 20° C. for 30 seconds using nitric acid, and first zincate treatment was performed at 20° C. for 30 seconds using a known zincate treatment solution. Next, de-zincate treatment was performed at 20° C. for 30 seconds using nitric acid, and then, secondary zincate treatment was performed at 20° C. for 30 seconds.

### <Plating Conditions>

### Example 1-1

In the first plating step of forming a lower layer on the surface of a substrate, plating treatment was performed to form a plating film with a thickness of 10 μm at 85° C. for 90 minutes using a known malic acid-succinic acid-based electroless NiP plating bath containing 1 ppm 2,2′-dipyridyl disulfide added thereto as an organosulfur compound. The surface roughness of the electroless NiP plating film was measured with an atomic force microscope (AFM) produced by Veeco (roughness is indicated as the average roughness Ra of 10 μm square). Consequently, the value of the surface roughness was 2.3 nm.

Then, the surface of the lower layer of the electroless NiP plating film was washed. Then, in the second plating step of forming an upper layer, plating treatment was performed to form a plating film with a thickness of 2 μm at 85° C. for 20 minutes using a known malic acid-succinic acid-based electroless NiP plating bath not containing an organosulfur compound added thereto, whereby a plating film with a total thickness of 12 μm was formed on the surface of the substrate.

### Comparative Example 1-1

Plating treatment was performed to form a plating film with a thickness of 12 μm at 85° C. for 120 minutes using a known malic acid-succinic acid-based electroless NiP plating bath not containing the aforementioned organosulfur compound added thereto. That is, plating treatment was performed using an electroless NiP plating bath that does not contain an organosulfur compound and has corrosion resistance against acid solutions.

### Comparative Example 1-2

Plating treatment was performed to form a plating film with a thickness of 12 μm at 85° C. for 120 minutes using a known malic acid-succinic acid-based electroless NiP plating bath containing 1 ppm of the organosulfur compound added thereto. That is, plating treatment was performed using an electroless NiP plating bath containing an organosulfur compound.

### (Measurement Results)

The surface roughness of each of the electroless NiP plating films of Example 1, Comparative Example 1-1, and Comparative Example 1-2 was measured with an atomic force microscope (AFM) produced by Veeco (roughness is indicated as the average roughness Ra of 10 μm square).

Further, the surface of each plating film was imaged with an optical microscope for visual check. Corrosion resistance against acid solutions was measured by immersing each of the electroless NiP plating films of Example 1-1, Comparative Example 1-1, and Comparative Example 1-2 in nitric acid (with a concentration of 30% and a temperature of 40° C.) for 5 minutes, and imaging the surface of each film with an optical microscope to count the number of corrosion pits in the field of view.

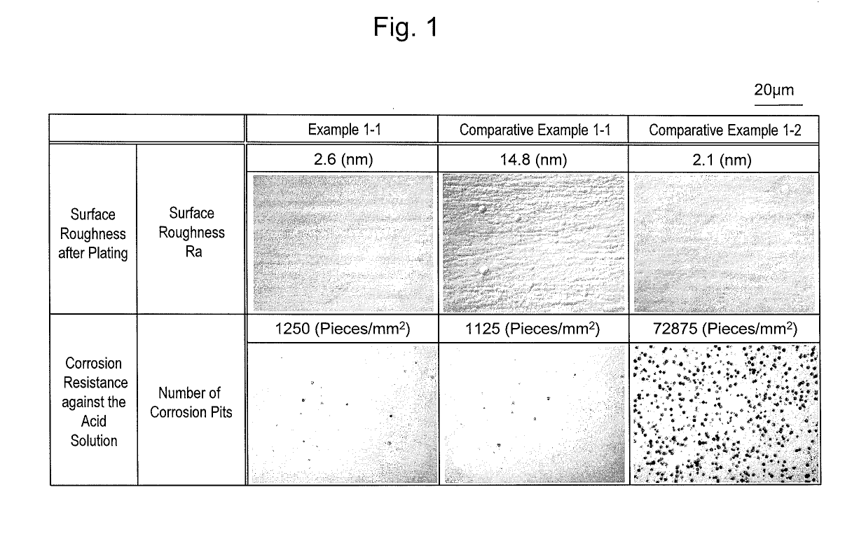

FIG. 1 is a diagram showing the measurement results of Example 1-1 and Comparative Examples 1-1 and 1-2.

In Example 1-1, the surface roughness Ra after the plating is 2.6 nm, and the number of corrosion pits is 1250 (pieces/mm²). In Comparative Example 1-1, the surface roughness Ra after the plating is 14.8 nm, and the number of corrosion pits is 1125 (pieces/mm²). In Comparative Example 1-2, the surface roughness Ra after the plating is 2.1 nm, and the number of corrosion pits is 72875 (pieces/mm²).

In Comparative Example 1-1, plating treatment was performed using an electroless NiP plating bath with corrosion resistance against acid solutions in the plating step. Thus, the number of corrosion pits is less than that in Example 1. However, as an organosulfur compound is not contained, the surface roughness Ra is greater than that in Example 1-1, and a plurality of minute irregularities can be observed on the surface of the plating film in FIG. 1. Thus, it is predicted that great burdens will be imposed on the polishing step in Comparative Example 1-1.

In Comparative Example 1-2, plating treatment was performed using an electroless NiP plating bath containing an organosulfur compound in the plating step. Thus, the surface roughness Ra is smaller than that in Example 1-1, and irregularities cannot be observed on the surface in FIG. 1. However, it is seen that the number of corrosion pits is far larger than that in Example 1-1, and the corrosion resistance against acid solutions is thus low. Thus, it is predicted that defects such as corrosion pits will be generated in the polishing step, and it is also predicted that an excess amount of Ni in the NiP plating film will elute in the washing step, which could influence the following steps for the hard disk substrate.

It is found that in comparison with Comparative Examples 1-1 and 1-2, the surface roughness Ra after the plating of Example 1 is smaller and smoother, and the film has a small number of corrosion pits and thus has higher corrosion resistance against acid solutions.

### Example 1-2

Samples with samples numbers 1-6 were produced by preparing a plurality of types of organosulfur compounds and performing plating under the same plating conditions as those in Example 1-1. Table 1 below is a table showing the name, the structural formula, and the amount of addition of each organosulfur compound.

TABLE 1

| | | | Amount of |
|---|---|---|---|
| Sample | | Structural | Addition |
| Number | Name of Additive | Formula | (ppm) |
| 1 | sodium thiosulfate | Na₂S₂O₂ | 0.75 |
| 2 | thiourea | CS(NH₂)₂ | 1 |
| 3 | sodium lauryl sulfate | C₁₂H₂₅SO₃Na | 2 |
| 4 | isothiazolone compound | C₄H₄NSClO | 0.75 |
| 5 | 2,2′-dipyridyl disulfide | C₁₀H₁₈N₂S₂ | 1 |
| 6 | naphthalenesulfonate condensate | (C₁₀H₄SO₃Na)n | 200 |

Then, the surface roughness of the electroless NiP plating film was measured with an atomic force microscope (AFM) produced by Veeco (roughness is indicated as the average roughness Ra of 10 μm square) as in Example 1-1.

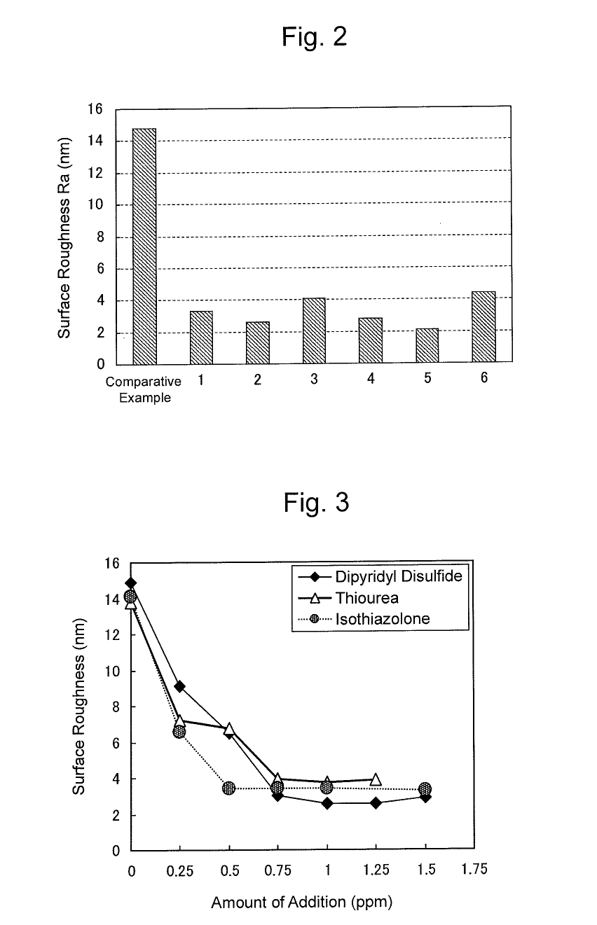

FIG. 2 is a diagram showing the measurement results of the surface roughness of each sample and the comparative example.

The comparative example in FIG. 2 corresponds to Comparative Example 1-1 described above. It is seen that the film of the comparative example has large surface roughness (Ra) (14.8 nm) as an organosulfur compound is not added, and has a rougher surface than the samples with Sample Numbers 1-6. Meanwhile, it is seen that the present example in which an organosulfur compound is added, that is, each of the samples with Sample Numbers 1-6 has small surface roughness (Ra), and has a smoother surface than the film of the comparative example. Among them, the samples with Sample Numbers 2, 4, and 5, in particular, have small surface roughness (Ra), and have a significantly high leveling effect. This is considered to be due to the influence of nitrogen contained in the organosulfur compound.

### Examples 1-3

Samples were produced using organosulfur compounds, which were found to have a particularly high leveling effect in Example 1-2 described above, that is, dipyridyl disulfide, thiourea, and isothiazolone, as additives. Then, (1) surface roughness, (2) the heights of nodules, and (3) waviness that serve as the indices of smoothness were measured and effects thereof were confirmed.

### (1) Measurement of the Surface Roughness

Samples were produced by changing the amount of addition of each additive by 0.25 ppm in the range of 0 to 1.5 ppm. Then, the surface roughness of the electroless NiP plating film of each sample was measured with an atomic force microscope (AFM) produced by Veeco (roughness is indicated as the average roughness Ra of 10 μm square) as in Example 1-1. Table 2 below is a table showing the measurement results of the surface roughness of each sample, and FIG. 3 is a graph of the results in Table 2.

TABLE 2

| Amount of | dipyridyl | thiourea | isothiazolone |
|---|---|---|---|
| Addition (ppm) | disulfide (nm) | (nm) | (nm) |
| 0.00 | 14.9 | 13.80 | 14.11 |
| 0.25 | 9.10 | 7.22 | 6.58 |
| 0.50 | 6.50 | 6.77 | 3.44 |
| 0.75 | 3.02 | 3.94 | 3.38 |
| 1.00 | 2.56 | 3.72 | 3.41 |
| 1.25 | 2.55 | 3.90 | — |
| 1.50 | 2.87 | — | 3.26 |

As shown in Table 2 and FIG. 3, it is seen that in comparison with the surface roughness of a sample produced without an organosulfur compound added thereto (i.e., the amount of addition=0.00 ppm), the surface roughness of a sample produced with an organosulfur compound added thereto (0.25 to 1.50 ppm), for example, thiourea, is reduced to about ⅓ at the maximum.

### (2) Heights of Nodules

In this example, a sample produced with 1.0 ppm dipyridyl disulfide added thereto, a sample produced with 0.75 ppm thiourea added thereto, and a sample produced with 0.5 ppm isothiazolone added thereto were produced. Then, the heights of nodules and the diameters of nodules were measured using an ultra-depth shape measuring microscope (“VK-851” produced by Keyence Corporation). As a comparative example, the heights of nodules and the diameters of nodules of Comparative Example 1-1 described above were also measured.

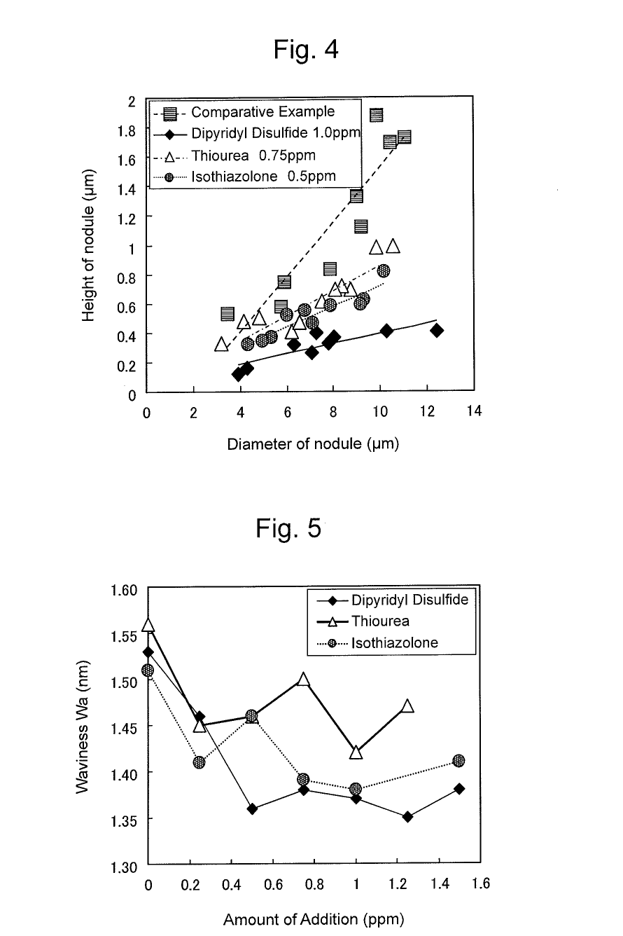

Table 3 below is a table showing the measurement results of the heights of nodules and the diameters of nodules of each example and the comparative example. FIG. 4 is a diagram showing the correlation among the measurement results.

TABLE 3

| | | dipyridyl disulfide | | thiourea | | isothiazolone | |
|---|---|---|---|---|---|---|---|
| Comparative Example | | 1.0 ppm | | 0.75 ppm | | 0.5 ppm | |
| Height(μm) | Diameter(μm) | Height(μm) | Diameter(μm) | Height(μm) | Diameter(μm) | Height(μm) | Diameter(μm) |
| 3.46 | 0.53 | 7.81 | 0.33 | 9.83 | 0.98 | 6.01 | 0.52 |
| 11.05 | 1.73 | 7.28 | 0.4 | 10.55 | 0.99 | 7.87 | 0.58 |
| 5.86 | 0.75 | 7.09 | 0.26 | 8.76 | 0.69 | 7.11 | 0.46 |
| 5.74 | 0.58 | 8.03 | 0.37 | 8.34 | 0.72 | 9.34 | 0.62 |
| 10.42 | 1.7 | 4.3 | 0.16 | 6.22 | 0.41 | 9.17 | 0.59 |
| 9.84 | 1.88 | 6.31 | 0.32 | 7.48 | 0.61 | 5.33 | 0.37 |
| 7.82 | 0.84 | 12.44 | 0.41 | 8.06 | 0.69 | 4.36 | 0.32 |
| 9.16 | 1.12 | 10.26 | 0.41 | 6.54 | 0.47 | 10.18 | 0.81 |
| 9 | 1.33 | 3.9 | 0.12 | 3.22 | 0.33 | 4.98 | 0.34 |
| | | | | 4.83 | 0.5 | 6.77 | 0.55 |
| | | | | 4.16 | 0.48 | | |

As shown in FIG. 4, it is seen that in each example in which an organosulfur compound is added, the height of each nodule with respect to the diameter of the nodule is reduced than that of the comparative example in which an organosulfur compound is not added.

### (3) Measurement of Waviness

Samples were produced by changing the amount of addition of each additive by 0.25 ppm in the range of 0 to 1.5 ppm. Then, waviness (Wa) of the surface of each sample at a wavelength of 5 mm was measured using a flatness measuring apparatus (“Opti flat” produced by KLA-Tencor). The waviness (Wa) was obtained by calculating the mean absolute value of the height (Z) at a wavelength of greater than or equal to 5 mm, and was calculated on the basis of the arithmetical mean waviness (Wa) indicated by JISB0601. Table 4 below is a table showing the measurement results of the waviness of the surface of each sample in accordance with the amount of addition, and FIG. 5 is a graph of the results in Table 4.

TABLE 4

| Amount of | dipyridyl | thiourea | isothiazolone |
|---|---|---|---|
| Addition (ppm) | disulfide (nm) | (nm) | (nm) |
| 0.00 | 1.53 | 1.56 | 1.51 |
| 0.25 | 1.46 | 1.45 | 1.41 |
| 0.50 | 1.36 | 1.46 | 1.46 |
| 0.75 | 1.38 | 1.50 | 1.39 |
| 1.00 | 1.37 | 1.42 | 1.38 |
| 1.25 | 1.35 | 1.47 | — |
| 1.50 | 1.38 | — | 1.41 |

As shown in Table 4 and FIG. 5, it was found that in comparison with a sample produced without an organosulfur compound added thereto (i.e., the amount of addition=0.00 ppm), a sample produced with an organosulfur compound added thereto (0.25 to 1.50 ppm) has reduced waviness and a smoother surface.

Accordingly, it was found that with respect to all of the indices: (1) surface roughness, (2) the heights of nodules, and (3) waviness, a sample produced with a nitrogen-containing organosulfur compound added thereto has a higher leveling effect than a sample produced without an organosulfur compound added thereto. Accordingly, it is considered that burdens on the polishing step can be reduced, and the productivity of hard disk substrates can thus be improved.

### Example 2

Example 2 was implemented to observe the state of generation of pits that are considered to be generated due to an oxide film generated on the surface of the lower layer of the plating film when plating is performed through the first plating step and the second plating step.

### <Pretreatment Conditions>

A commercially available 3.5-inch aluminum substrate with an average surface roughness of Ra=15 nm was subjected to degreasing treatment at 50° C. for 2 minutes using a degreasing liquid containing known soda phosphate and surfactant. Then, the substrate was subjected to etching treatment at 70° C. for 2 minutes using a known etching solution containing sulfuric acid and phosphoric acid.

Next, desmutting treatment was performed at 20° C. for 30 seconds using nitric acid, and first zincate treatment was performed at 20° C. for 30 seconds using a known alkaline zincate treatment solution. Further, de-zincate treatment was performed at 20° C. for 30 seconds using nitric acid, and then, secondary zincate treatment was performed at 20° C. for 30 seconds using the same zincate treatment solution as that in the first zincate treatment.

### <Plating Conditions for Lower Layer>

In the first plating step, plating treatment was performed at 85° C. for 120 minutes using a known electroless NiP bath (i.e., first plating bath) containing hypophosphite as a reducing agent, so that a smooth lower layer of an electroless NiP plating film with a thickness of 12 μm was formed (i.e., first plating step). Then, the surface of the lower layer of the electroless NiP plating film was washed with pure water for 10 minutes.

### <Polishing Conditions for the Surface of the Lower Layer>

The surface of the lower layer of the electroless NiP plating film was subjected to a fine polishing process in two stages, using an urethane foam polishing pad and a polishing solution containing free abrasive grains dispersed therein, so that a mirror surface was obtained. In that case, a polishing solution containing dispersed therein alumina abrasive grains with a high processing speed was used in the first-stage polishing, and a polishing solution containing dispersed therein colloidal silica abrasive grains with a further smaller grain size was used in the second-stage polishing. The film was polished to a depth of 2.0 μm from the surface using such polishing methods.

### <Oxide Film Removing Process>

The lower layer of the electroless NiP plating film obtained through mirror finish under the aforementioned polishing conditions was immersed in a degreasing liquid containing known soda phosphate and surfactant (“Alclean 160” produced by Okuno Chemical Industries Co., Ltd.) at 50° C. for 1 minute, so that the oxide film on the surface of the lower layer was removed and an active surface immediately after the plating was reproduced.

<Transport Conditions from the First Plating Bath to the Second Plating Bath>

### Example 2-1

The substrate produced with the aforementioned production method was washed with pure water (i.e., washing step), and the substrate was transported in about 10 seconds while the substrate was maintained in a wet condition in which pure water adhered to the surface of the lower layer of the plating film. Immediately after that, the substrate was immersed in a second plating bath in the second plating step, whereby an upper layer of the electroless NiP plating film was formed.

### Comparative Example 2-1

The substrate produced with the aforementioned production method was washed with pure water (i.e., washing step), and the surface of the lower layer of the plating film was held in the air for 30 minutes so as to be dried. Then, the substrate was immersed in a second plating bath in the second plating step, whereby an upper layer of the electroless NiP plating film was formed.

### Comparative Example 2-2

The substrate produced with the aforementioned production method was washed with pure water, and was kept in the air for 1 week so that the surface of the lower layer became completely dry. Then, the substrate was immersed in a second plating bath in the second plating step, whereby an upper layer of the electroless NiP plating film was formed.

### <Plating Conditions for the Upper Layer>

In the second plating step, plating treatment was performed at 85° C. for 30 minutes using a known electroless NiP plating bath (i.e., second plating bath) not containing an organosulfur compound added thereto and containing hypophosphite as a reducing agent, so that an upper layer of the electroless NiP plating film with a thickness of 3 μm was formed on the lower layer of the electroless NiP plating film. That is, the lower layer of the electroless NiP plating film was formed to a thickness of 10 μm, and the upper layer was formed to a thickness of 3 μm.

The present invention is directed to a production method for solving the problem of pits that are generated when an electroless NiP plating film with a two-layer structure is formed. The cause of the generation of such pits is an oxide film that is formed on the surface of the lower layer of the plating film as described above, and does not depend on the presence or absence of an additive in the lower layer of the electroless NiP plating film. Thus, in this example, a smooth substrate obtained by polishing an electroless NiP plating film, which has been obtained using an electroless NiP plating bath not containing an additive with leveling action, was used to form a smooth lower layer of an electroless NiP plating film as a simulation test.

### <Measurement Results>

The number of recess defects on the surface of the upper layer of the electroless NiP plating film was measured using a laser microscope (i.e., nano search microscope “OLS3500” produced by Olympus Corporation, 100× objective lens (a field of view of 128 μm×96×μm, a differential interference laser). Then, the number of mesh-like recess defects that were checked in scanning the substrate surface every 90° (0°′ 90°′ 180°, and 370°) from the inner circumference to the outer circumference thereof was measured.

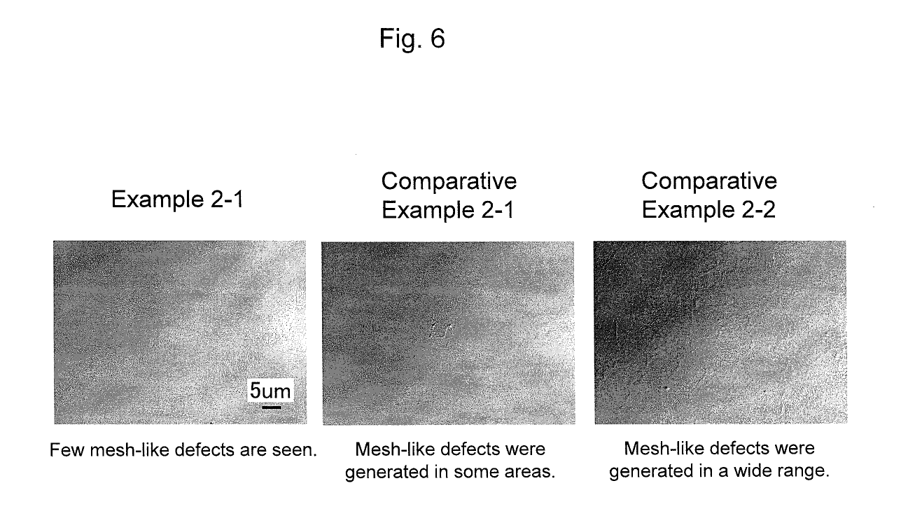

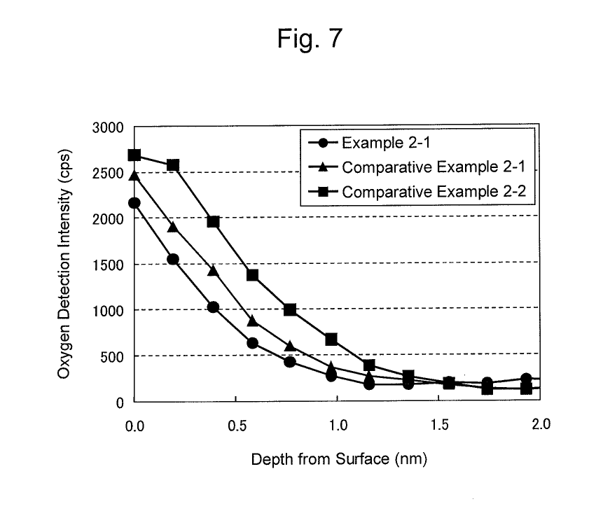

For the measurement of the thickness of the oxide film on the surface of the upper layer of the electroless NiP plating film, an FE auger electron spectrometer (“JAMP-9500F” produced by JEOL Ltd.) was used. A depth profile that collects the oxygen element spectrum of the entire 1000× image was analyzed every second during argon etching, and the etch depth at that time was calculated on the basis of the etch rate of the silicon oxide substrate. Table 5 and FIG. 7 show the measurement results thereof. FIG. 6 shows an image of the surface of the upper layer of the plating film in Example 2.

TABLE 5

| | Transport Time in | | State of Substrate | Thickness of Oxide Film | Number of Mesh-like |
|---|---|---|---|---|---|
| | Air between Lower | | Surface Immediately | on Substrate Surface | Recess Defecs after |
| | Layer Plating and | | before Upper | Immediately before Upper | Upper Layer Plating |
| | Upper Layer Plating | | Layer Plating | Layer Plating (nm) | (Number/mm²) |
| Example 2-1 | 10 | Seconds | Wet | 1.2 | 0.2 |
| Comparative Example 2-1 | 30 | Minutes | Dry | 1.4 | 1.7 |
| Comparative Example 2-2 | 1 | Week | Dry | 1.7 | Unmeasurable |

In Example 2-1, the transport time in the air after the removal of the oxide film till the start of the upper layer plating was 10 seconds, and the substrate surface (the surface of the lower layer) immediately before the upper layer plating was in a wet condition. The thickness of the oxide film on the substrate surface immediately before the upper layer plating was 1.2 nm, and the number of mesh-like recess defects on the surface of the plating film after the upper layer plating was 0.2 pieces/mm². In Example 2-1, few mesh-like recess defects were found as shown in FIG. 6.

In contrast, in Comparative Example 2-1, the transport time in the air after the removal of the oxide film till the start of the upper layer plating was 30 minutes, and the substrate surface immediately before the upper layer plating was in a dry condition. The thickness of the oxide film on the substrate surface immediately before the upper layer plating was 1.4 nm, and the number of mesh-like recess defects on the surface of the plating film after the upper layer plating was 1.7 pieces/mm². In Comparative Example 2-1, mesh-like recess defects were generated in some areas as shown in FIG. 6.

Meanwhile, in Comparative Example 2-2, the transport time in the air after the removal of the oxide film till the start of the upper layer plating was 1 week, and the substrate surface immediately before the upper layer plating was in a dry condition. The thickness of the oxide film on the substrate surface immediately before the upper layer plating was 1.7 nm, and the number of mesh-like recess defects on the surface of the plating film after the upper layer plating was too many to measure. In Comparative Example 2-2, mesh-like recess defects were generated in a wide range as shown in FIG. 6.

From the aforementioned results, it is found that when the transport time in the air after the removal of the oxide film till the start of the upper layer plating is short, and the substrate surface immediately before the upper layer plating is held in a wet condition, it is possible to reduce the thickness of an oxide film formed on the surface of the lower layer of the plating film and thus reduce the number of mesh-like recess defects that are generated after the upper layer plating.

1. A method for producing a hard disk substrate with an electroless NiP plating film, comprising:
a first plating step of immersing a substrate in a first electroless NiP plating bath containing an additive with leveling action, thereby forming a lower layer of the electroless NiP plating film on a surface of the substrate, the lower layer having smaller average surface roughness than the surface; and
a second plating step of immersing the substrate that has the lower layer of the electroless NiP plating film formed thereon through the first plating step in a second electroless NiP plating bath, thereby forming an upper layer of the electroless NiP plating film, the upper layer having corrosion resistance against acid solutions,
wherein exposure of the lower layer to the atmosphere is suppressed in a period during transition from the first plating step to the second plating step.

2. The method for producing a hard disk substrate according to claim 1, further comprising a washing step of washing the substrate with a wash solution after the first plating step, wherein after the washing step, a wet condition in which the wash solution adheres to a surface of the lower layer is maintained to suppress exposure of the lower layer to the atmosphere.
